(19) United States
(12) Patent Application Publication
(10) Pub. No.: US 2014/0324486 A1
(43) Pub. Date: Oct. 30, 2014

(54) TRAVEL OPTION PRESENTATION

(71) Applicant: HIPMUNK, INC., San Francisco, CA (US)

(72) Inventors: Adam Julian Goldstein, San Francisco, CA (US); Steven Ladd Huffman, San Francisco, CA (US); Joseph M. Gambescia, III, San Francisco, CA (US); Christopher Brian Slowe, San Francisco, CA (US)

(73) Assignee: HIPMUNK, INC., SAN FRANCISCO, CA (US)

(21) Appl. No.: 13/869,682

(22) Filed: Apr. 24, 2013

(51) Int. Cl. G06Q 30/06; G06Q 10/02

(52) U.S. Cl. CPC G06Q 30/0627; G06Q 10/02
USPC 705/5

(57) ABSTRACT

A machine may be configured to provide a travel shopping service, not only to direct users of the machine, but also to users of other travel shopping services provided by partner websites whose operators have entered into partnership agreements with an operator of the machine. The machine may provide a common module to one or more partner websites or operators thereof. When a user views a partner website in a browser, the common module configures and causes the browser to obtain and implement a custom module generated or updated specifically for that partner website. The custom module configures and causes the browser to communicate with the machine, for example, in response to fulfillment conditions specified by the operator of the partner website and used as a basis for generating or updating the custom module. Information obtained from the machine may then be presented by the browser to the user.

### TECHNICAL FIELD

The subject matter disclosed herein generally relates to the processing of data. Specifically, the present disclosure addresses systems and methods to facilitate presentation of travel options.

### BACKGROUND

A machine may be configured as a web server that supports a travel-related website, and such a travel-related website may offer one or more travel shopping services. A travel shopping service provided by such a website may enable a user to submit some travel criteria (e.g., as search criteria) and search for available travel reservations (e.g., as search results). The travel shopping service may then present one or more available travel reservations to the user within the user's web browser. In many cases, the user may use her web browser to make a presented travel reservation or otherwise initiate a transaction to reserve or purchase a corresponding travel option.

For example, a website for an airline may allow a user to submit dates, times, and locations of departure and arrival, and then present the user with available flights that match the submitted dates, times, and locations. As another example, a website for a hotel may allow a user to submit a check-in date, a checkout date, and a number of guests, and then present the user with available hotel stays that match the submitted check-in date, checkout date, and number of guests. If the user does not like any of the presented travel reservations (e.g., available flights or available hotel stays), the user may decide to view a different website in her web browser (e.g., view the website of another travel shopping service, or view a separate website for something entirely unrelated) or close her web browser entirely (e.g., end her web browser's session).

### BRIEF DESCRIPTION OF THE DRAWINGS

Some embodiments are illustrated by way of example and not limitation in the figures of the accompanying drawings.

FIG. 1 is a network diagram illustrating a network environment suitable for presentation of travel options, according to some example embodiments.

FIG. 2 is a block diagram illustrating components of a server machine suitable for presentation of travel options, according to some example embodiments.

FIG. 3 is a block diagram illustrating components of a server machine forming all or part of a partner website, according to some example embodiments.

FIG. 4 is a block diagram illustrating components of a device suitable for presentation of travel options, according to some example embodiments.

FIG. 5 is a flowchart illustrating data flows within the network environment, according some example embodiments.

FIG. 6-7 are flowcharts illustrating operations of the server machine in performing a method of presenting travel options, according to some example embodiments.

FIG. 8 is a block diagram illustrating a data structure storing a set of conditions suitable for presentation of travel options, according to some example embodiments.

FIG. 9-11 are layout diagrams illustrating a user interface suitable for presentation of travel options, according to some example embodiments.

FIG. 12 is a block diagram illustrating components of a machine, according to some example embodiments, able to read instructions from a machine-readable medium and perform any one or more of the methodologies discussed herein.

### DETAILED DESCRIPTION

Example methods and systems are directed to presentation of travel options (e.g., as examples of presented search results). Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A machine (e.g., a server machine within a network-based travel shopping system) may be configured to provide a travel shopping service, not only to direct users of the machine, but also to users of other travel shopping services provided by partner websites. Such partner websites may include websites of airlines, hotels, hotel chains, and travel agencies whose operators (e.g., administrators or managers) have entered into a partnership agreement with an operator of the machine that provides the travel shopping service. According to various example embodiments, the machine may provide a common module (e.g., a common software module, such as a common line of code) to one or more partner websites or operators thereof. When a user views a partner website in a browser, the common module configures and causes the browser to obtain and implement a custom module (e.g., a custom software module, such as a website-specific line of code) that is generated or updated specifically for that partner website. The custom module configures and causes the browser to communicate with the machine (e.g., enable the machine to access information stored by the browser and obtain information provided by the machine or otherwise available from the machine). Moreover, the custom module may configure and cause the browser to do this in response to fulfillment of a set of conditions, which may be specified by the operator of the partner website and used by the machine as a basis for generating or updating the custom module. Information obtained by the browser from the machine may then be presented by the browser to the user.

For example, if a partner website (e.g., for an airline or a hotel) has caused the browser of the user to present the user with an available travel reservation (e.g., for an available airline flight or an available hotel stay), but the user does not proceed to make the available travel reservation (e.g., if the user closes her browser, declines an offer to make the travel reservation, or opens a different website in her browser), the user may be presented with additional available travel reservations that have been selected by the machine. In some example embodiments, the user is first presented with a dialog box asking if the user wishes to see additional available travel reservations, before the user is presented with the additional available travel reservations (e.g., in response to an affirmative reply to the dialog box).

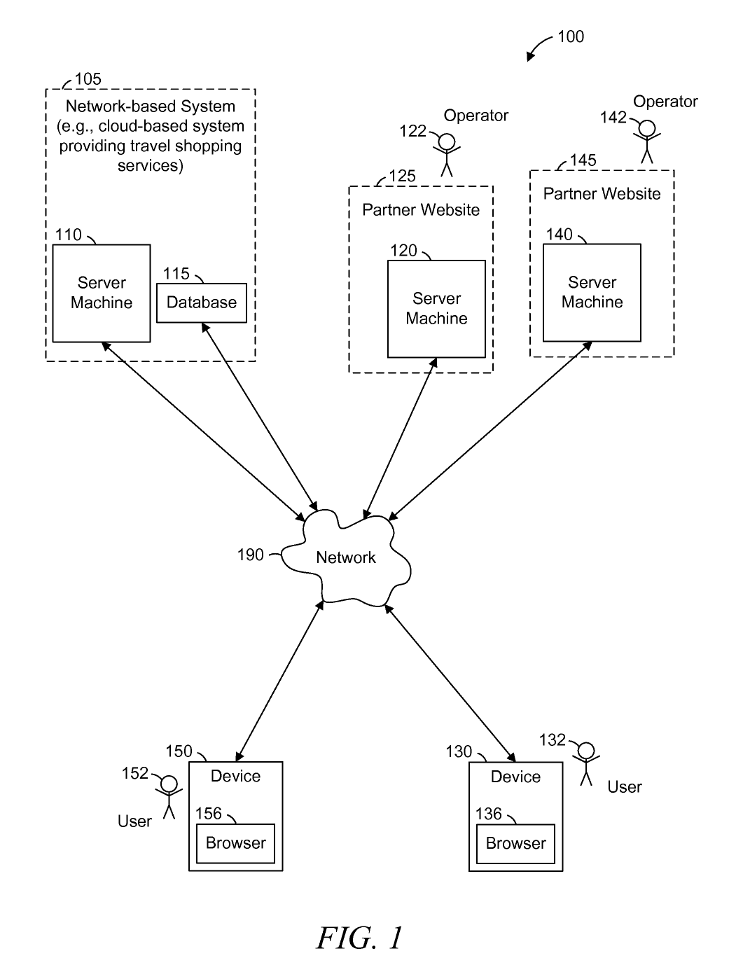

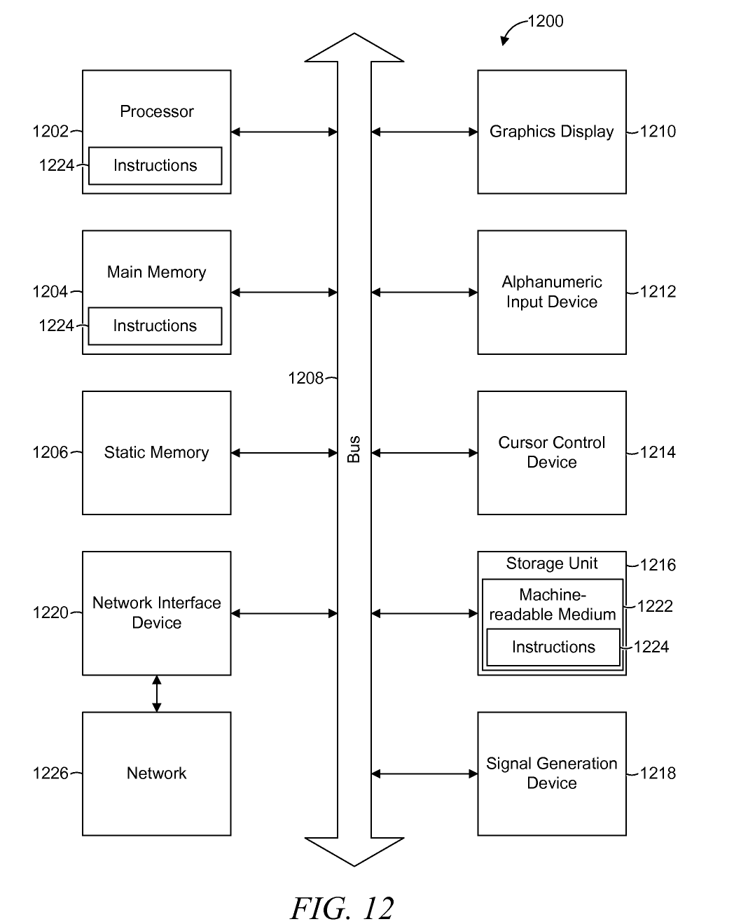

FIG. 1 is a network diagram illustrating a network environment 100 suitable for presentation of travel options, according to some example embodiments. The network environment 100 includes a server machine 110, a database 115, server machines 120 and 140 for partner websites 125 and 145, and devices 130 and 150, all communicatively coupled to each other via a network 190. The server machines 110, 120, and 140 and the devices 130 and 150 each may be implemented in a computer system, in whole or in part, as described below with respect to FIG. 12.

As shown, the server machine 110, with or without the database 115, may form all or part of a network-based system 105. For example, the network-based system 105 may be a cloud-based system that one or more travel shopping services (e.g., a search engine or recommendation engine for airline flights, hotel stays, or any suitable combination of travel options that are available for reservation or purchase). FIG. 1 also depicts the server machine 120 forming all or part of the partner website 125, which may be operated (e.g., administered or managed) by an operator 122. The operator 122 is not part of the network environment 100, but is associated with (e.g., corresponds to) the server machine 120 and the partner website 125. FIG. 1 additionally depicts the server machine 140 forming all or part of the partner website 145, which may be operated by an operator 142. The operator 142 is not part of the network environment 100, but is associated with the server machine 140 and the partner website 145.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, or a smart phone belonging to the user 132. Likewise, the user 152 is not part of the network environment 100, but is associated with the device 150. As an example, the device 150 may be a desktop computer, a vehicle computer, a tablet computer, a navigational device, a portable media device, or a smart phone belonging to the user 152.

The device 130 is shown as including a browser 136 (e.g., browser application that is stored in a memory of the device 130 or being executed by a processor of the device 130). The user 132 may therefore use the browser 136 to interact with the network-based system 105, the partner website 125, the partner website 145, or any suitable combination thereof. Similarly, the device 150 is shown as including a browser 156. The user 152 may therefore use the browser 156 to interact with the network-based system 105, the partner website 125, the partner website 145, or any suitable combination thereof.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 12. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

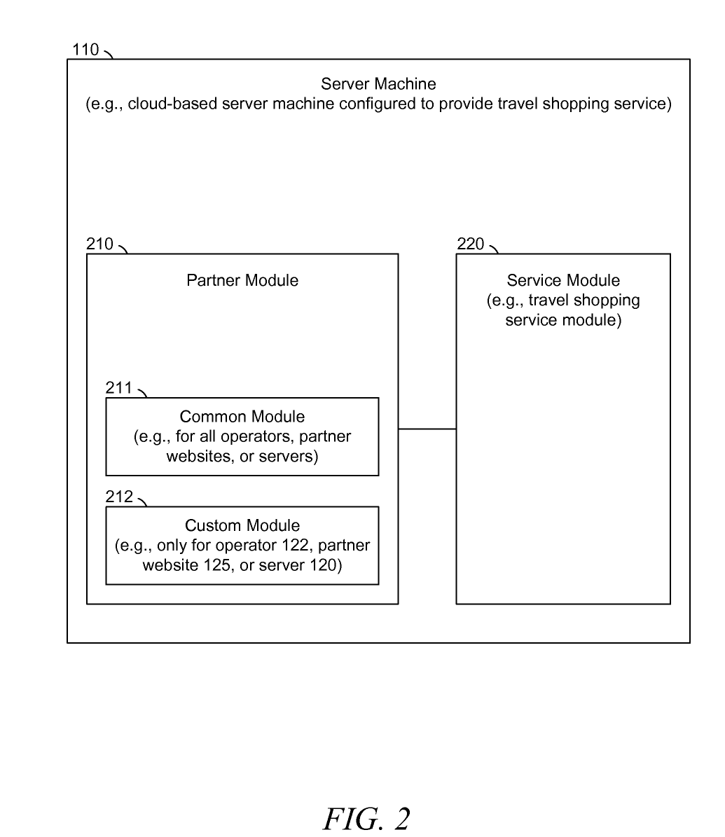

FIG. 2 is a block diagram illustrating components of the server machine 110, which may be configured (e.g., by software, hardware, or both) as a cloud-based server machine that provides one or more network-based travel shopping services, according to some example embodiments. The server machine 110 is shown as including a partner module 210 and the service module 220, which may be configured to communicate with each other (e.g., via a bus, shared memory, or a switch).

The partner module 210 may be configured to interact with one or more partner websites (e.g., partner websites 125 and 145), their corresponding operators (e.g., operators 122 and 142), their corresponding server machines (e.g., server machines 120 and 140), or any suitable combination thereof. The partner module 210 is shown as including (e.g., by referencing or by storing) a common module 211, which may be generated or updated by the partner module 210. As discussed in greater detail below, the common module 211 may configure the browser 136 to obtain one or more additional modules that further configure the browser 136. The common module 211 may be generated for, updated for, and implementable by multiple partner websites (e.g., partner websites 125 and 145) collectively, their respective operators (e.g., operators 122 and 142) collectively, their respective server machines (e.g., server machines 120 and 140) collectively, or any suitable combination thereof.

The partner module 210 is shown as also including (e.g., by referencing or by storing) a custom module 212, which may be generated or updated by the partner module 210 specifically for one of multiple partner websites individually (e.g., specifically for the partner website 125), its corresponding operator (e.g., operator 122) individually, its corresponding server machine (e.g., server machine 120) individually, or any suitable combination thereof. As discussed in greater detail below, the custom module 212 may configure the browser 136 to perform one or more actions that involve the server machine 110.

Moreover, the partner module 210 may generate or update the custom module 212 based on a set of conditions received from the server machine 120. For example, such a set of conditions may be specified by the operator 122 of the partner website 125 and provided to the partner module 210, which may be configured to generate or update the custom module 212 in response to reception of the set of conditions.

The service module 220 may be configured to provide one or more network-based services (e.g., cloud-based travel shopping services) to various users (e.g., users 132 and 152), their corresponding devices (e.g., devices 130 and 150), browsers executing on those devices (e.g., browsers 136 and 156), or any suitable combination thereof. The service module 220 may be or include a travel shopping service module, and may provide one or more travel shopping services to various users (e.g., users 132 and 152) via their respective devices (e.g., devices 130 and 150).

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

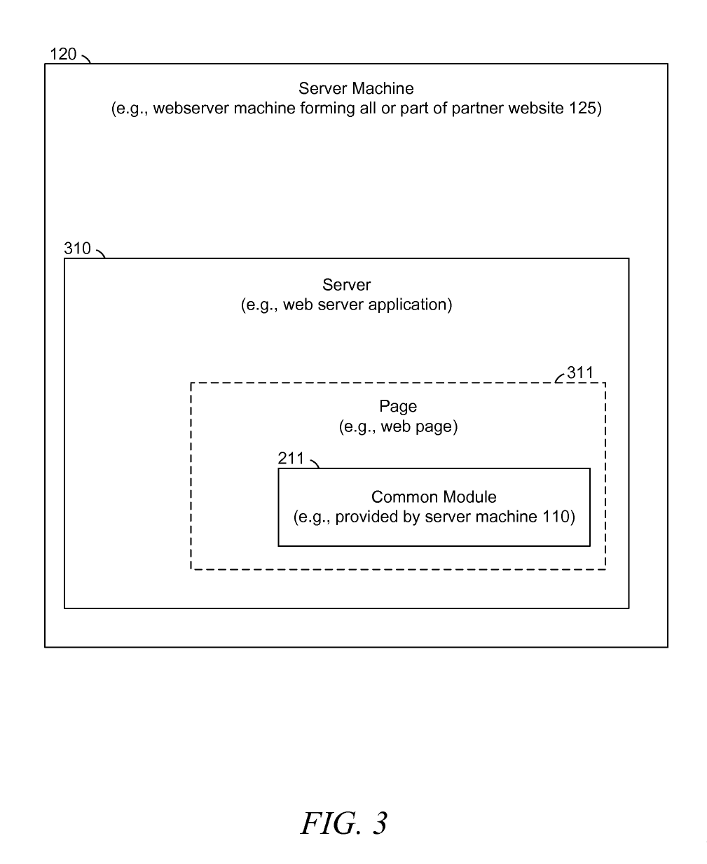

FIG. 3 is a block diagram illustrating components of the server machine 120 within the partner website 125, according to some example embodiments. The server machine 120 may be configured (e.g., software, hardware, or both) as a webserver machine that forms all or part of the partner website 125. The server machine 120 is shown as including a server 310 (e.g., a web server application being executed by the server machine 110). The server 310 is shown as including (e.g., by referencing or by storing) the common module 211, which may be provided by, or obtained from, the server machine 110. For example, the common module 211 may be included in a page 311 (e.g., a web page) that is served or otherwise made available by the server 310.

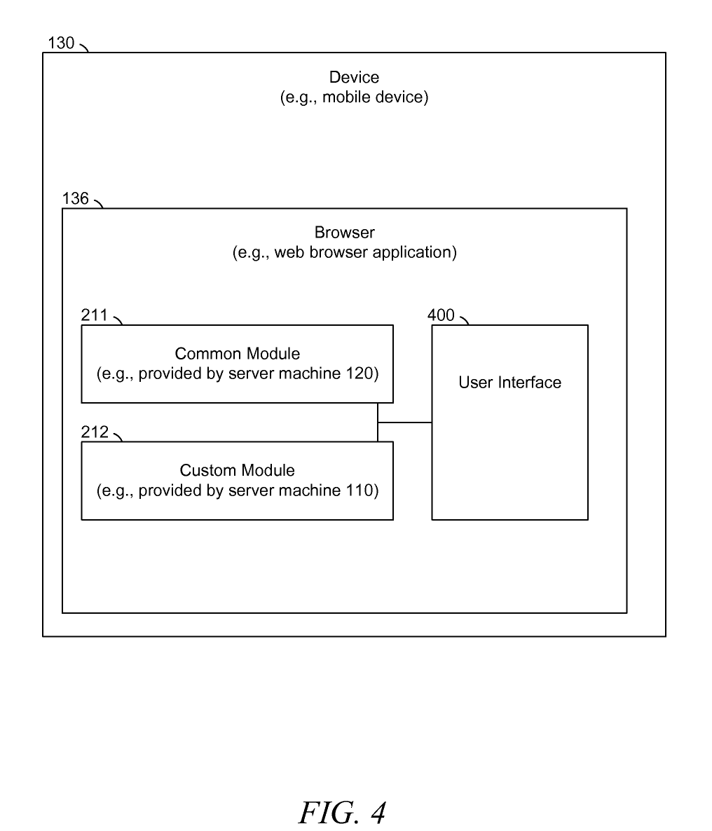

FIG. 4 is a block diagram illustrating components of the device 130, which may be configured (e.g., by the browser 136) for presentation of travel options, according to some example embodiments. The device 130 is shown as including the browser 136 (e.g., a web browser application), which may be executing on the device 130.

The browser 136 is shown as including (e.g., a referencing or by storing) the common module 211, which may be provided by, or obtained from, the server machine 120 in the partner website 125. The browser 136 is shown as also including the custom module 212, which may be provided by, or obtained from, the server machine 110 in the network-based system 105. Additionally, the browser 136 is shown as including user interface 400 (e.g., a graphical user interface) by which information may be presented (e.g., displayed or played) to the user 132. For example, all or part of the page 311 may be requested and obtained from the server 310 by the browser 136 and thereafter presented to the user 132 by the user interface 400.

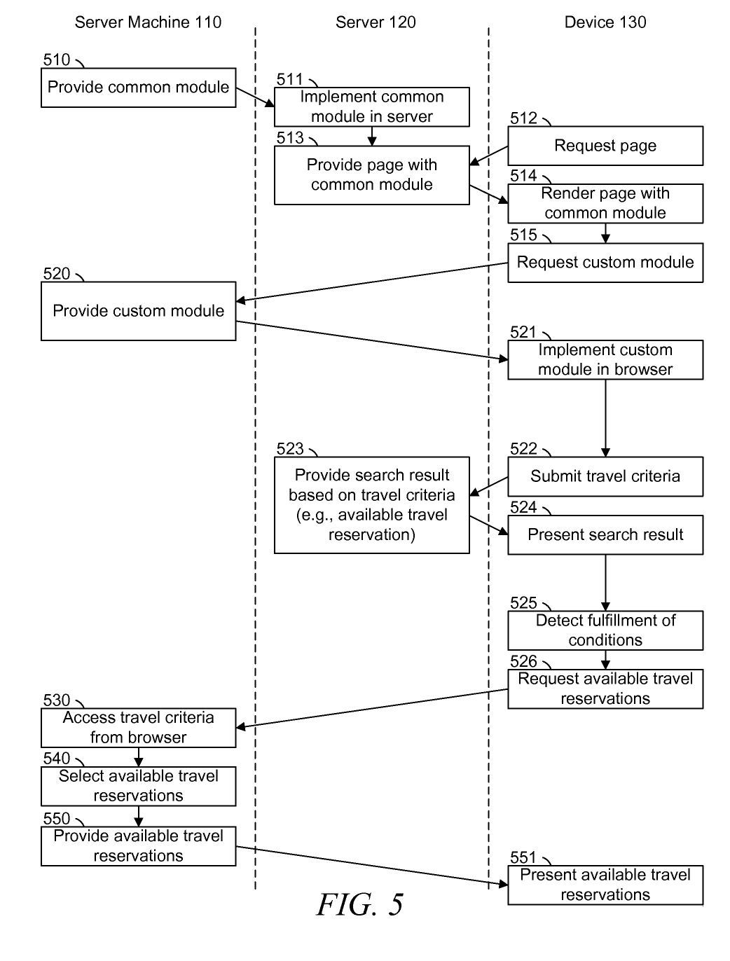

FIG. 5 is a flowchart illustrating data flows within the network environment 100, according some example embodiments. In operation 510, the server machine 110 in the network-based system 105 provides the common module 211 to the server 120 in the partner website 125, to the operator 122 of the website 125, or both. In operation 511, the server 120 receives and implements the common module 211 (e.g., by including the common module 211 within the page 311).

In operation 512, the device 130 (e.g., via the browser 136) requests the page 311 from the server machine 120 of the partner website 125. For example, the page 311 may be web page that includes a search engine for travel options that are available for reservation through the partner website 125 (e.g., available travel reservations from the server machine 120). At this point in the data flow, the browser 136 may be configured to receive and present a web page (e.g., page 311), as well as configured to receive an implement a module (e.g., common module 211) that accompanies the web page, that is referenced by the web page, or that is included in the web page.

In operation 513 the server machine 120 in the partner website 125 provides the page 311 in response to the request. As noted above, the page 311 may include the common module 211 (e.g., as shown in FIG. 3). Thus, the common module 211 may be provided with the page 311 to the browser 136.

In operation 514, the device 130 renders the page 311 (e.g., in the user interface 400 of the browser 136) and implements the common module 211 received with the page 311. In particular, the browser 136 executing on the device 130 may implement the common module 211 (e.g., as shown in FIG. 4). Moreover, the browser 136 may be configured by the page 311 to submit one or more travel criteria to the partner website 125 (e.g., via its server machine 120), receive one or more results of a search performed by the partner website 125 (e.g., via its server machine 120) based on the submitted travel criteria, and present such results of the search to the user 132. Furthermore, the browser 136 may be configured by the common module 211 to obtain (e.g., request and receive) and implement the custom module 212 from the server machine 110 in the network-based system 105.

In operation 515, the device 130 (e.g., via the browser 136) requests the custom module 212 from the server machine 110. In operation 520, the server machine 110 responds by providing the custom module 212 to the device 130.

In operation 521, the device 130 (e.g., via the browser 136, as configured by the common module 211) implements the custom module 212 within the browser 136. The custom module 212 may configure the browser 136 to detect fulfillment of a set of conditions (e.g., specified by the operator 122 of the partner website 125), obtain information on one or more travel options that are available for reservation through the network-based system 105 (e.g., available travel reservations from the server machine 110), present such travel options in response to the fulfillment of the set of conditions (e.g., within the user interface 400 of the browser 136), or any suitable combination thereof.

In operation 522, the device 130 (e.g., via the browser 136, as configured by the page 311) submits travel criteria (e.g., entered by the user 132) to the server 120 of the partner website 125. In operation 523, the server 120 provides a result (e.g., a full or partial description of an available travel reservation) of a search performed by the server 120 based on the submitted travel criteria. The result is shown as being provided to the device 130. In operation 524, the device 130 (e.g., via the browser 136, as configured by the page 311) presents the result of the search (e.g., the available travel reservation from server 120) to the user 132 (e.g., in the user interface 400 of the browser 136).

In operation 525, the device 130 (e.g., via the browser 136, as configured by the custom module 212) detects fulfillment of a set of conditions. As noted above, the set of conditions may be specified by the operator 122 of the partner website 125. For example, the set of conditions may be received by the server machine 110 and incorporated (e.g., hardcoded or otherwise implemented) into the custom module 212.

In some example embodiments, detection of the fulfillment of the set of conditions causes the device (e.g., via the browser 136, as configured by the custom module 212) to display a pop-up dialog box that asks the user 132 to indicate whether the user 132 would like to view other travel options that are available for reservation. For example, such a pop-up dialog box may be presented to confirm that the user 132 would appreciate such information, before proceeding to obtain and present such information.

Based on (e.g., in response to) the detected fulfillment of the set of conditions, in operation 526, the device 130 (e.g., by the browser 136, as configured by the custom module 212) may request information on one or more travel options that are available for reservation through the network-based system 105 (e.g., available travel reservations from the server machine 110). The server machine 110 in the network-based system 105 may respond by performing one or more of operations 530, 540, and 550.

In operation 530, the server machine 110 in the network-based system 105 accesses the travel criteria that were previously submitted to the server 120 in the partner website 125. The server machine 110 may access the travel criteria from the browser 136 executing on the device 130. This may have the effect of allowing the server machine 110 to figuratively “look over the shoulder” of the user 132 and learn what the user 132 entered as travel criteria in using the page 311.

In operation 540, the server machine 110 in the network-based system 105 selects one or more travel options that are available for reservation through the network-based system 105 (e.g., available travel reservations from the server machine 110). For example, the server machine 110 may execute its own search engine for travel options, and this search engine may be used to determine one or more available travel reservations that are bookable through the server machine 110. In some example embodiments, the selecting of the one or more travel options is in response to an affirmative reply to a dialog box (e.g., presented by the browser 136) that asks whether presentation of one or more travel options proposed by the network-based system 105 (e.g., as provider of the custom module 212) is desired by the user 132 of the browser 136.

In operation 550, the server machine 110 in the network-based system 105 provides information on its selected travel options (e.g., full or partial descriptions of available travel reservations from the server machine 110) to the device 130 (e.g., via the browser 136, as configured by the custom module 212). In operation 551, the device 130 (e.g., via the browser 136, as configured by the custom module 212) presents this information to the user 132 (e.g., in the user interface 400 of the browser 136).

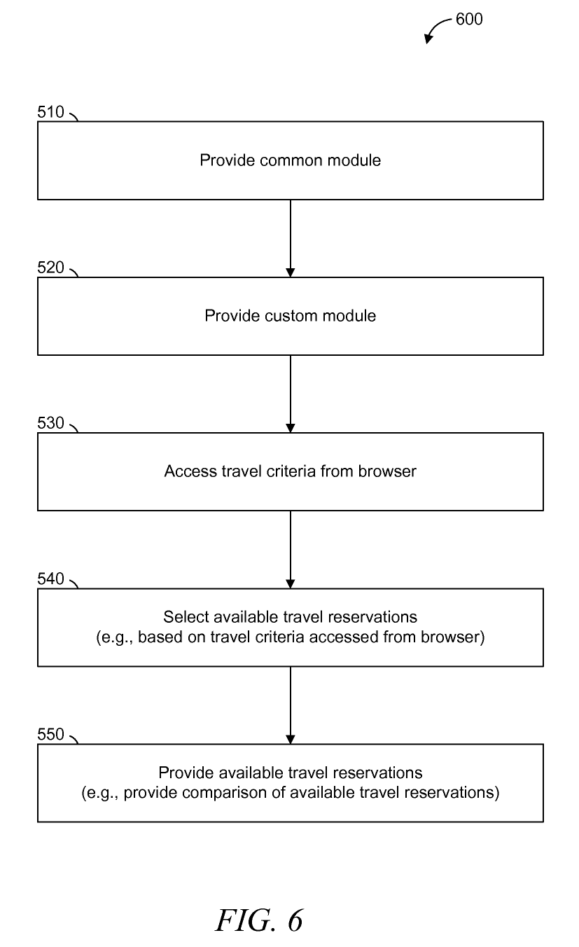

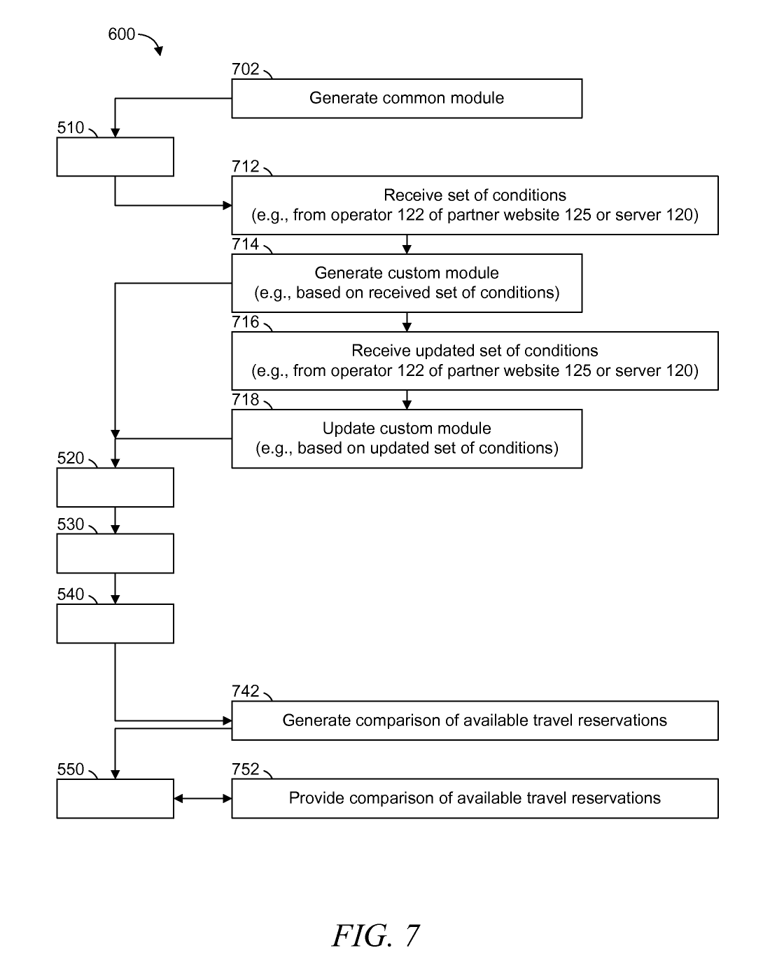

FIG. 6-7 are flowcharts illustrating operations 510-550 of the server machine 110 in performing a method 600 of presenting travel options, according to some example embodiments. Operations and the method 600 may be performed by one or more modules described above with respect to FIG. 2. As shown in FIG. 6, the method 600 includes operations 510, 520, 530, 540, and 550, which were briefly described above with respect to FIG. 5.

In operation 510, the partner module 210 of the server machine 110 provides the common module 211 (e.g., a copy of the common module 211) to the server 120 in the partner website 125, to its operator 122, or to both. As noted above, the common module 211 is implementable by each of the partner websites 125 and 145, each of their corresponding server machines 120 and 140, or any suitable combination thereof. An example embodiment of such an implementation is described above with respect to FIG. 3. Each of the partner websites 125 and 145, each of their corresponding server machines 120 and 140, or any suitable combination thereof, may be configured to provide the common module 211 (e.g., with or within a page, such as the page 311) to the browser 136 during a session of the browser 136 (e.g., a browser session in which the browser 136 communicates with the server 310 executing on the server machine 120).

The browser 136 may be configured (e.g., by its own software) to receive the common module 211 (e.g., with or within a page, such as the page 311) from a partner website (e.g., partner website 125 or its corresponding server machine 120). As noted above, the browser 136 may be configured (e.g., by loading the page 311) to submit one or more travel criteria to the partner website 125 (e.g., via its server machine 120), receive one or more results of a search performed by the partner website 125 (e.g., via its server machine 120) based on the submitted travel criteria, and present such results of the search to the user 132 (e.g., via the user interface 400).

After requesting, receiving, and rendering the page 311 from the server machine 120 of the partner site 125, the browser 136 may be configured (e.g., by loading the common module 211 that accompanied the page 311) to obtain and implement the custom module 212 from the server machine 110 (e.g., via its partner module 210). The custom module 212 may be specific to the partner website 125 (e.g., generated or updated specifically for the partner website 125, its operator 122, its corresponding server machine 120, or any suitable combination thereof). For example, the custom module 212 may be generated or updated based on a set of conditions, which may be generated by and received from the operator 122 (e.g., via the server machine 120).

In operation 520, the partner module 210 of the server machine 110 provides the custom module 212 to the device 130 on which the browser 136 executes. The custom module 212 may be provided directly to the browser 136, for example, in response to a request for the custom module 212 (e.g., submitted to the partner module 210 by the browser 136, as configured by the common module 211). Moreover, provision of the custom module 212 may be performed during the same browser session discussed above with respect to operation 510.

The browser 136 may be configured (e.g., by the provided custom module 212) to detect fulfillment of a set of conditions, which may be generated by the operator 122 of the partner website 125. The set of conditions may be specified by the operator 122 for presentation of one or more travel options that are available for reservation through the network-based system 105 (e.g., available travel reservations from the server machine 110, which provided the custom module 212). The browser 136 may be further configured (e.g., by the custom module 212) to obtain such travel options (e.g., as available travel options) from the server machine 110. The browser 136 may additionally be configured (e.g., by the custom module 212) to present such travel options obtained from the server machine 110 (e.g., as available travel reservations, in response to the fulfillment of the set of conditions).

In operation 530, the service module 220 of the server machine 110 accesses the travel criteria submitted by the browser 136 to the partner website 125. The submitted travel criteria may be accessed from the browser 136, as configured by the custom module 212. The accessing of the travel criteria may be performed in response to a request for one or more travel options that are available for reservation through the network-based system 105 (e.g., travel reservations from the server machine 110, which provided the custom module 212 to the browser 136).

In operation 540, the service module 220 of the server machine 110 selects one or more travel options that are available for reservation to the network-based system 105 (e.g., available travel reservations from the server machine 110). The selection of such travel options may be performed based on the travel criteria accessed in operation 530. For example, operation 540 may be performed by submitting one or more of the travel criteria to a search engine for travel options (e.g., a travel search engine hosted by the network-based system 105, the server machine 110, or both). Travel options selected by the server machine 110 may be different from travel options previously provided in operation 523 by the server 120 of the partner website 125 to the device 130.

In operation 550, the service module 220 of the server machine 110 provides information on the travel options selected in operation 540 to the device 130. The information on the travel options may be provided to the browser 136, as configured by the custom module 212. Such information may include a full or partial description of an available travel reservation that is a bookable through the network-based system 105. Provision of such information may enable the browser 136 to present this information to the user 132 (e.g., via user interface 400). Moreover, provision of such information may be in response to a request for one or more travel options that are available for reservation through the network-based system 105 (e.g., travel reservations from the server machine 110, which provided the custom module 212 to the browser 136).

As shown in FIG. 7, the method 600 may include one or more of operations 702, 712, 714, 716, 718, 742, and 752. Operation 702 may be performed prior to operation 510, in which the partner module 210 of the server machine 110 provides the common module 211. In operation 702, the partner module 210 generates the common module 211. In some example embodiments, the common module 211 is generated as a single line of code (e.g., computer programming code) that is implementable by each of several partner websites (e.g., partner websites 125 and 145, their corresponding server machines 120 and 140, or any suitable combination thereof).

Operations 712 and 714 may be performed prior to operation 520, in which the partner module 210 of the server machine 110 provides the custom module 212. In operation 712, the partner module 210 receives a set of conditions that is usable as a basis for generating (e.g., creating) the custom module 212. The set of conditions may be generated by and received from the operator 122 of the partner website 125 (e.g., via its server machine 120). The set of conditions may specify when to trigger a presentation of one or more travel options that are available for reservation through the network-based system 105. In operation 714, the partner module 210 generates the custom module 212 based on the set of conditions received in operation 712. For example, the custom module 212 may be generated to include code (e.g., computer programming code) that configures the browser 136 to perform operations 525, 526, and 551 when one or more conditions within the set of conditions are fulfilled.

Operations 716 and 718 may be performed prior to operation 520, in which the partner module 210 of the server machine 110 provides the custom module 212. In operation 716, the partner module 210 receives an updated set of conditions (e.g., an update to the set of conditions) that is usable as a basis for updating (e.g., modifying or revising) the custom module 212. The updated set of conditions may be submitted by and received from the operator 122 of the partner website 125 (e.g., via its server machine 120). The updated set of conditions may modify when to trigger a presentation of one or more travel options that are available for reservation through the network-based system 105. In operation 718, the partner module 210 updates the custom module 212 based on the updated set of conditions received in operation 716. For example, the custom module 212 may be updated to include code (e.g., computer programming code) that configures the browser 136 to perform operations 525, 526, and 551 when one or more revised or new conditions within the updated set of conditions are fulfilled.

Operation 742 may be performed between operations 540 and 550, as shown in FIG. 7. In operation 742, the service module 220 generates a comparison of travel options that were selected in operation 540. For example, the service module 220 may generate a presentation that compares two or more available travel reservations selected in operation 540. Such a presentation may include full or partial descriptions (e.g., prices) of multiple available travel reservations (e.g., in a side-by-side arrangement or a vertical list).

Operation 752 may be performed as part (e.g., a precursor task, a subroutine, or a portion) of operation 550, in which the service module 220 provides information on the travel options selected in operation 540 to the device 130 (e.g., via the browser 136). In operation 752, the comparison of travel options generated in operation 742 is provided by the service module 220 to the device 130. For example, the comparison may be provided to the browser 136, as configured by the custom module 212. The providing of this comparison may be in response to a request for one or more travel options that are available for reservation through the network-based system 105 (e.g., travel reservations from the server machine 110). This may enable the device 130 (e.g., via the user interface 400 of the browser 136) to present the comparison to the user 132 (e.g., as part of performing operation 551).

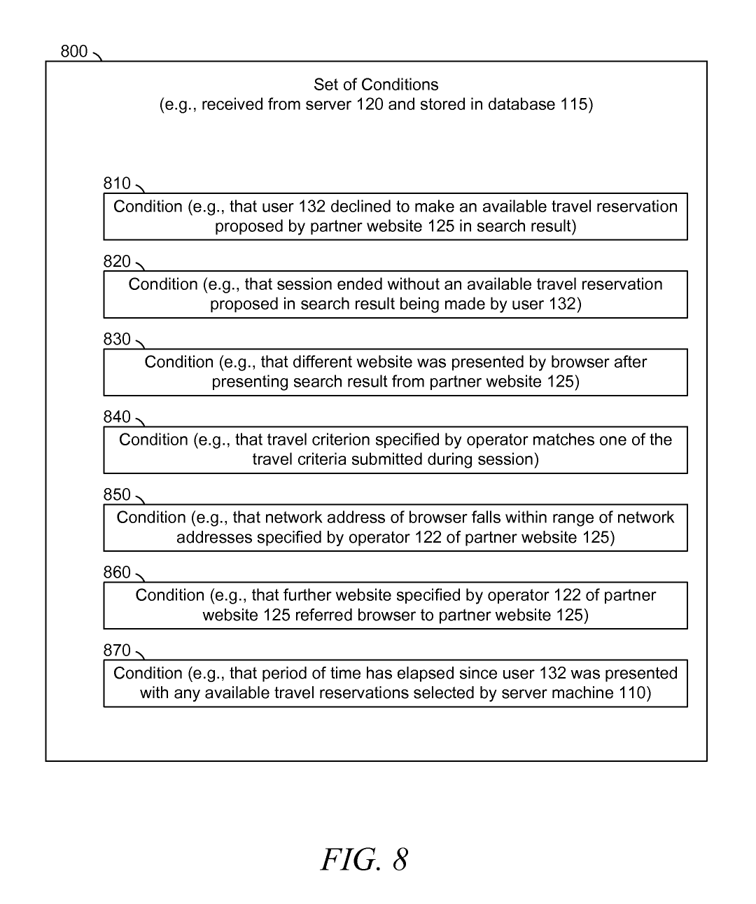

FIG. 8 is a block diagram illustrating a data structure storing a set 800 of conditions 810-870, according to some example embodiments. The set 800 of conditions 810-870 may be generated or updated, in whole or in part, by the operator 122 of the partner website 125. The set 800 of conditions 810-870 may be provided from the server machine 120 of the partner website 125 to the server machine 110 of the network-based system 105. In particular, the set 800 of conditions 810-870 may be received by the partner module 210 and used, in whole or in part, as a basis for generating or updating the custom module 212. Moreover, the set 800 of conditions 810-870 may be stored in the database 115 (e.g., for use by the partner module 210 of the server machine 110).

As shown in FIG. 8, the set 800 includes one or more conditions 810, 820, 830, 840, 850, 860, and 870. The condition 810 may be a condition that the user 132 declined to make an available travel reservation that was proposed by the partner website 125 in one of the search results discussed above with respect to operation 523 in FIG. 5. For example, the page 311 may be rendered in the browser 136 with a button or link by which the user 132 may decline to make one or more of the available travel reservations that were presented as search results from the partner website 125. The custom module 212 may configure the browser 136 to detect that such a button or link has been activated, which may fulfill the condition 810.

The condition 820 may be a condition that the browser session has ended without the user 132 making an available travel reservation proposed by the partner website 125 in one of the search results discussed above with respect to operation 523 in FIG. 5. For example, the user 132 may attempt or request to close the browser 136 (e.g., by issuing an exit command) after the browser 136 has displayed some available travel reservations obtained from the partner website 125, but before any information stored by the browser 136 indicates that at least one of those available travel reservations has been made (e.g., reserved, purchased, or otherwise procured) by the user 132. The custom module 212 may configure the browser 136 to detect this situation, which may fulfill the condition 820.

The condition 830 may be a condition that a different website was presented by the browser 136 after presenting one or more of the search results discussed above with respect to operation 523 in FIG. 5. For example, while the browser 136 is displaying available travel reservations from the partner website 125, the user 132 may decide to abandon the partner website 125 and direct the browser 136 to display an entirely different website altogether (e.g., a social networking website that offers no travel shopping services). The custom module 212 may configure the browser 136 to detect this abandonment (e.g., detect a request to open a new website), which may fulfill the condition 830.

The condition 840 may be a condition that one or more travel criteria specified by the operator 122 matches one or more of the travel criteria submitted to the partner website 125 by the user 132 (e.g., via the browser 136). For example, the operator 122 may wish to confine the presentation of travel options from the network-based system 105 to only those situations in which certain travel criteria have been submitted by users (e.g., user 132). Such travel criteria may be incorporated (e.g., as trigger criteria) into the condition 840. The custom module 212 may configure the browser 136 to detect that one or more of such travel criteria has been submitted by the user 132 (e.g., via the browser 136), which may fulfill the condition 840.

Examples of such a travel criterion include an airline option, a car rental option, an accommodation option, as well as similar options for transportation, accommodation, or both. Examples of an airline option include a takeoff time, a takeoff date, a landing time, a landing date, a class of service, a membership in a rewards program, a seat row number, a departure airport, an arrival airport, and any suitable combination thereof. Examples of a car rental option include a car rental date, a car return date, a car type, a car manufacturer, a car model, a car color, and any suitable combinations thereof. Examples of an accommodation option (e.g., a hotel option) include a city, a neighborhood, a check-in date, check-in time, a check-out date, a check-out time, a class of service, a membership in a rewards program, a floor number, a number of occupants, an accommodation brand, and any suitable combination thereof.

The condition 850 may be a condition that a network address of the browser 136 (e.g., an Internet Protocol (IP) address of the device 130) falls within a range of network addresses (e.g., IP addresses) that have been specified by the operator 122 of the partner website 125. For example, the operator 122 may wish to confine the presentation of travel options from the network-based system 105 to only those devices (e.g., devices 130 and 150) that are located in certain geographical regions indicated by certain network addresses. Such network addresses may be incorporated (e.g., as allowable ranges) into the condition 850. The custom module 212 may configure the browser 136 to detect that the network address of the browser 136 falls within a specified range of network addresses, which may fulfill the condition 850.

The condition 860 may be a condition that a particular website specified by the operator 122 referred the browser 136 to the partner website 125. For example, an identifier of the referring website (e.g., website 145) may be stored by the browser 136, prior to the browser 136 requesting the page 311 from the partner website 125 (e.g., as described above with respect to operation 512 in FIG. 5). Such an identifier may be incorporated into the condition 860. The custom module 212 may configure the browser 136 to detect this identifier being stored by the browser 136, which may fulfill the condition 860.

The condition 870 may be a condition that a period of time (e.g., a predetermined threshold period of time) has elapsed since the user 132 was presented with any travel option selected by the server machine 110. Such a period of time may be specified by the operator 122. In some example embodiments, the period of time is generated by the partner module 210 of the server machine 110 (e.g., as specified by an administrator of the server machine 110). For example, it may be helpful to avoid situations where the user 132 is frequently presented with unsolicited travel options from websites other than the website to which the user 132 has directed the browser 136 (e.g., partner website 125). Accordingly, presentation of travel options that are selected by the server machine 110 may be confined to only those situations where the period of time has expired. In some example embodiments, travel options selected by the server machine 110 may be presented only once or twice per browser session. Hence, the specified period of time may be incorporated into the condition 870. The custom module 212 may configure the browser 136 to detect expiration of the period of time, which may fulfill the condition 870.

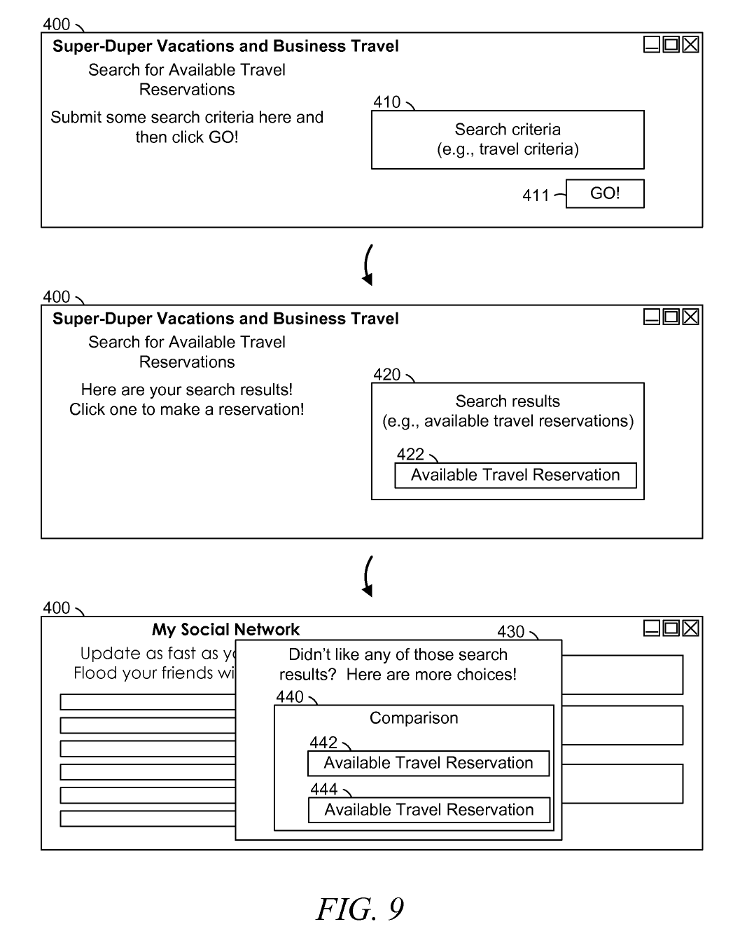

FIG. 9-11 are layout diagrams illustrating the user interface 400, which may be configured for presentation of travel options, according to some example embodiments. FIG. 9-11 depict what the user 132 may experience at various points during performance of one or more of the methodologies described herein.

As shown in the top portion of FIG. 9, the user interface 400 may be used to present all or part of the page 311, as rendered in operation 514 of FIG. 5. The page 311 is provided to the browser 136 and its user interface 400 by the server machine 120 of the partner website 125. In this state, the user interface 400 may be configured to submit search criteria 410 (e.g., travel criteria) to the partner website 125. A button 411 is shown to indicate that the search criteria 410 have not yet been submitted.

As shown in the middle portion of FIG. 9, the user interface 400 may be used to present search results 420 (e.g., available travel reservations) that are provided by the server machine 120 of the partner website 125. The user interface 400 may continue to present all or part of the page 311, as provided by the server machine 120 of the partner website 125. An available travel reservation 422 is illustrated within the search results 420, as an example of potentially multiple search results 420.

As shown in the bottom portion of FIG. 9, the user interface 400 has been requested (e.g., by the user 132) to abandon the page 311 from the partner website 125 and instead display an entirely different page from entirely different website (e.g., social networking website). The user interface 400 presents the user 132 with a graphical window 430 (e.g., a pop-up window) that includes a comparison 440 of available travel reservations 442 and 444. The graphical window 430 may be presented in response to fulfillment of some or all of the set 800 of conditions 810-870. This may have the effect of leveraging the interest previously shown by the user 132 in searching for available travel reservations (e.g., available travel reservation 422), presenting the user 132 with additional available travel reservations (e.g., available travel reservations 442 and 444), and offering the user 132 with an additional opportunity to make such an available travel reservation.

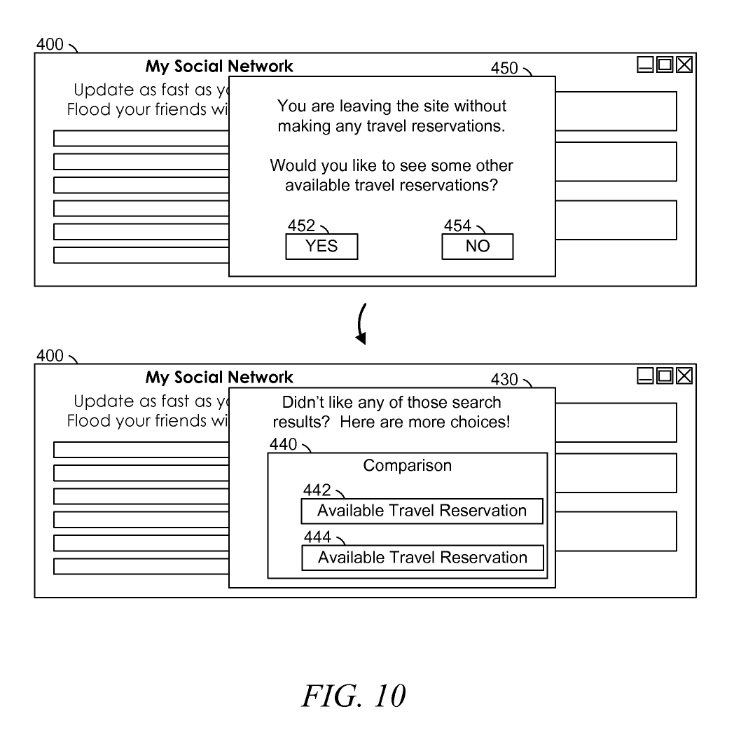

FIG. 10 depicts a scenario similar to that described above with respect to FIG. 9, but with an additional confirmation dialog box (e.g., to avoid annoying the user 132 with unsolicited information on travel options). As shown in the upper portion of FIG. 10, the user interface 400 has been requested to abandon the page 311 from the partner website 125 and instead display a social networking website. The user interface 400 presents the user 132 with a confirmation dialog box 450 that allows the user 132 to choose whether additional travel options will be shown. A “yes” button 452 and a “no” button 454 are provided in the confirmation dialog box 450 for the user 132 to indicate his choice. An affirmative reply (e.g., via the “yes” button 452) to the confirmation dialog box 450 may indicate that presentation of one or more travel options proposed by the network-based system 105 (e.g., as provider of the custom module 212) is desired by the user 132 of the browser 136. A negative reply (e.g., via the “no” button 454) the confirmation dialog box 450 may indicate that presentation of any travel options proposed by the network-based system 105 is not desired by the user 132.

Presentation of the confirmation dialog box 450 may be in response to fulfillment of some or all of the set 800 of conditions 810-870 (e.g., including, or in addition to, the requested abandonment of the page 311 from the partner website 125). This may have the effect of leveraging the interest previously shown by the user 132 in searching for available travel reservations (e.g., available travel reservation 422) and asking whether the user 132 would like to continue searching for a suitable available travel reservation (e.g., available travel reservation 442).

As shown in the lower portion of FIG. 10, the user 132 has clicked the “yes” button 452, and the user interface 400 presents the user 132 with the graphical window 430 (e.g., a pop-up window) that includes the comparison 440 of the available travel reservations 442 and 444. This may have the effect of presenting the user 132 with additional available travel reservations (e.g., available travel reservations 442 and 444) and offering the user 132 with an additional opportunity to make such an available travel reservation.

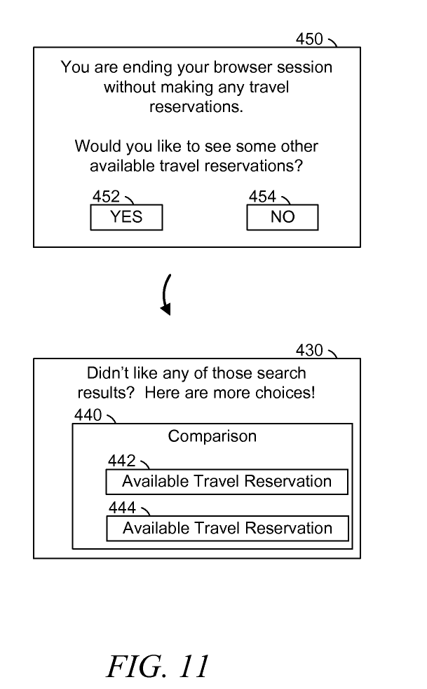

FIG. 11 depicts a scenario similar to those described above with respect to FIG. 10, but in which the user 132 has requested the browser 136 to exit (e.g., close). As shown in the upper portion of FIG. 11, the user interface 400 has been closed in response to the request to exit the browser 136. Prior to fully exiting, the browser 136 presents the user 132 with the confirmation dialog box 450, which allows the user 132 to choose whether additional travel options will be shown. As noted above, the “yes” button 452 and the “no” button 454 are provided in the confirmation dialog box 450 for the user 132 to indicate his choice. Presentation of the confirmation dialog box 450 may be in response to fulfillment of some or all of the set 800 of conditions 810-870 (e.g., including, or in addition to, the requested closure of the browser 136). This may have the effect of leveraging the interest previously shown by the user 132 in searching for available travel reservations (e.g., available travel reservation 422) and asking whether the user 132 would like to continue searching for a suitable available travel reservation (e.g., available travel reservation 442).

As shown in the lower portion of FIG. 11, the user 132 has clicked the “yes” button 452, and the browser 136 (e.g., prior to fully exiting) presents the user 132 with the graphical window 430 (e.g., a pop-up window) that includes the comparison 440 of the available travel reservations 442 and 444. This may have the effect of presenting the user 132 with additional available travel reservations (e.g., available travel reservations 442 and 444) and offering the user 132 with an additional opportunity to make such an available travel reservation.

According to various example embodiments, one or more of the methodologies described herein may facilitate presentation of one or more travel options (e.g., as available travel reservations). Moreover, one or more of the methodologies described herein may facilitate presentation of available travel reservations from one source (e.g., network-based system 105) after a user (e.g., user 132) has failed to make an available travel reservation from another source (e.g., partner website 125). Hence, one or more the methodologies described herein may facilitate increased convenience for users, as well as increased capture of user interest by travel-related websites operating in cooperation with each other.

When these effects are considered in aggregate, one or more of the methodologies described herein may obviate a need for certain efforts or resources that otherwise would be involved in presenting travel options selected by different sources. Efforts expended by a user in identifying a satisfactory travel option may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 12 is a block diagram illustrating components of a machine 1200, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 12 shows a diagrammatic representation of the machine 1200 in the example form of a computer system and within which instructions 1224 (e.g., software, a program, an application, an applet, an app, or other executable code) for causing the machine 1200 to perform any one or more of the methodologies discussed herein may be executed, in whole or in part. In alternative embodiments, the machine 1200 operates as a standalone device or may be connected (e.g., networked) to other machines. In a networked deployment, the machine 1200 may operate in the capacity of a server machine or a client machine in a server-client network environment, or as a peer machine in a distributed (e.g., peer-to-peer) network environment. The machine 1200 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1224, sequentially or otherwise, that specify actions to be taken by that machine. Further, while only a single machine is illustrated, the term “machine” shall also be taken to include a collection of machines that individually or jointly execute the instructions 1224 to perform all or part of any one or more of the methodologies discussed herein.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The machine 1200 may further include a graphics display 1210 (e.g., a plasma display panel (PDP), a light emitting diode (LED) display, a liquid crystal display (LCD), a projector, or a cathode ray tube (CRT)). The machine 1200 may also include an alphanumeric input device 1212 (e.g., a keyboard), a cursor control device 1214 (e.g., a mouse, a touchpad, a trackball, a joystick, a motion sensor, or other pointing instrument), a storage unit 1216, a signal generation device 1218 (e.g., a speaker), and a network interface device 1220.

The storage unit 1216 includes a machine-readable medium 1222 on which are stored the instructions 1224 embodying any one or more of the methodologies or functions described herein. The instructions 1224 may also reside, completely or at least partially, within the main memory 1204, within the processor 1202 (e.g., within the processor's cache memory), or both, during execution thereof by the machine 1200. Accordingly, the main memory 1204 and the processor 1202 may be considered as machine-readable media. The instructions 1224 may be transmitted or received over a network 1226 (e.g., network 190) via the network interface device 1220.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1222 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 1200), such that the instructions, when executed by one or more processors of the machine (e.g., processor 1202), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
providing each of multiple operators of travel websites with a common module that is implementable by each of the travel websites,
each of the travel websites being configured to provide the common module to a browser during a session of the browser,
the browser being configured to:
receive the common module from a travel website among the travel websites during the session,
submit travel criteria to the travel website during the session,
present a result of a search performed by the travel website based on the travel criteria during the session,
the browser being configured by the common module to obtain a custom module specific to the travel website from a provider of the common module during the session;
providing the custom module to the browser during the session,
the custom module configuring the browser to:
detect fulfillment of a set of conditions specified by an operator of the travel website for presentation of available travel reservations proposed by the provider of the custom module,
obtain the available travel reservations from the provider, and
present the available travel reservations in response to the fulfillment of the set of conditions;
accessing the travel criteria from the browser;
selecting the available travel reservations based on the travel criteria, the selecting being performed by a processor of a machine; and
providing the available travel reservations to the browser.

2. The method of claim 1 further comprising:
generating the common module prior to the providing of the common module to the multiple operators of the travel websites.

3. The method of claim 1 further comprising:
generating the custom module specific to the travel website based on the set of conditions specified by the operator of the travel website.

4. The method of claim 1 further comprising:
receiving the set of conditions from the operator of the travel website; and
updating the custom module specific to the travel website in response to the receiving of the set of conditions.

5. The method of claim 1, wherein:
the providing of the available travel reservations includes providing a comparison of the available travel reservations to the browser; and
the custom module configures the browser to present the comparison of the available travel reservations.

6. The method of claim 1, wherein:
the set of conditions includes a condition that a user to whom the result of the search was presented declined to make a further available travel reservation proposed by the travel website in the result of the search.

7. The method of claim 1, wherein:
the set of conditions includes a condition that the session ended without a further available travel reservation proposed in the result of the search being made by a user to whom the result was presented.

8. The method of claim 1, wherein:
the set of conditions includes a condition that a different website was presented by the browser after the browser presented the result of the search performed by the travel website.

9. The method of claim 1, wherein:
the set of conditions includes a condition that a travel criterion specified by the operator of the travel website matches one of the travel criteria submitted during the session.

10. The method of claim 9, wherein:
the travel criterion specified by the operator of the travel website indicates an airline option selected from a group consisting of a takeoff time, a takeoff date, a landing time, a landing date, a class of service, a membership in a rewards program, a seat row number, a departure airport, and an arrival airport.

11. The method of claim 9, wherein:
the travel criterion specified by the operator of the travel website indicates a car rental option selected from a group consisting of a car rental date, a car return date, a car type, a car manufacturer, a car model, and a car color.

12. The method of claim 9, wherein:
the travel criterion specified by the operator the travel website indicates an accommodation option selected from a group consisting of a city, a neighborhood, a check-in date, check-in time, a check-out date, a check-out time, a class of service, a membership in a rewards program, a floor number, a number of occupants, and an accommodation brand.

13. The method of claim 1, wherein:
the set of conditions includes a condition that a network address of the browser falls within a range of network addresses specified by the operator of the travel website.

14. The method of claim 1, wherein:
the set of conditions includes a condition that a further website specified by the operator of the travel website caused the browser to display the travel website during the session.

15. The method of claim 1, wherein:
the set of conditions includes a condition that a period of time has elapsed since a user of the browser was presented with any available travel reservations selected by the provider of the custom module.

16. The method of claim 1, wherein:
the selecting of the available travel reservations is in response to an affirmative reply to a dialog box that is presented by the browser and that asks whether presentation of the available travel reservations proposed by the provider of the custom module is desired by a user of the browser.

17. A non-transitory machine-readable storage medium comprising instructions that, when executed by one or more processors of a machine, cause the machine to perform operations comprising:
providing each of multiple operators of travel websites with a common module that is implementable by each of the travel websites,
each of the travel websites being configured to provide the common module to a browser during a session of the browser,
the browser being configured to:
receive the common module from a travel website among the travel websites during the session,
submit travel criteria to the travel website during the session,
present a result of a search performed by the travel website based on the travel criteria during the session,
the browser being configured by the common module to obtain a custom module specific to the travel website from a provider of the common module during the session;
providing the custom module to the browser during the session,
the custom module configuring the browser to:
detect fulfillment of a set of conditions specified by an operator of the travel website for presentation of available travel reservations proposed by the provider of the custom module,
obtain the available travel reservations from the provider, and
present the available travel reservations in response to the fulfillment of the set of conditions;
accessing the travel criteria from the browser;
selecting the available travel reservations based on the travel criteria, the selecting being performed by the one or more processors; and
providing the available travel reservations to the browser.

18. The non-transitory machine-readable storage medium of claim 17, wherein the operations further comprise:
receiving the set of conditions from the operator of the travel website; and
updating the custom module specific to the travel website in response to the receiving of the set of conditions.

19. A system comprising:
a partner module configured to:
provide each of multiple operators of travel websites with a common module that is implementable by each of the travel websites,
each of the travel websites being configured to provide the common module to a browser during a session of the browser,
the browser being configured to:
receive the common module from a travel website among the travel websites during the session,
submit travel criteria to the travel website during the session,
present a result of a search performed by the travel website based on the travel criteria during the session,
the browser being configured by the common module to obtain a custom module specific to the travel website from a provider of the common module during the session; and
provide the custom module to the browser during the session,
the custom module configuring the browser to:
detect fulfillment of a set of conditions specified by an operator of the travel website for presentation of available travel reservations proposed by the provider of the custom module,
obtain the available travel reservations from the provider, and
present the available travel reservations in response to the fulfillment of the set of conditions; and
a processor configured by a service module to:
access the travel criteria from the browser;
select the available travel reservations based on the travel criteria; and
provide the available travel reservations to the browser.

20. The system of claim 19, wherein:
the service module configures the processor to provide the available travel reservations by providing a comparison of the available travel reservations to the browser; and
the custom module configures the browser to present the comparison of the available travel reservations.
